(19) United States
(12) Patent Application Publication
(10) Pub. No.: US 2021/0022372 A1
(43) Pub. Date: Jan. 28, 2021

(54) DRY CONCENTRATE FOR PREPARATION OF A PROTEIN COCKTAIL

(71) Applicant: "BIO 8", Limited Liability Company, Moscow (RU)

(72) Inventors: Anton Lvovich Prozumentov, Moscow (RU); Georgiy Viktorovich Sarychev, Moscow (RU); Vera Konstantinovna Vedmina, Moscow (RU); Ivan Sergeevich Martynenko, Barnaul, Altai region (RU)

(21) Appl. No.: 16/331,507

(22) PCT Filed: Jun. 22, 2018
(86) PCT No.: PCT/RU2018/000413

§ 371 Date: Mar. 7, 2019

(51) Int. Cl. A23L 2/39; A23L 2/66; A23L 25/00; A23L 33/155; A23L 33/16; A23L 33/185; A23L 33/19; A23L 33/18; A23L 33/22; A23L 33/24; A23L 2/60

(52) U.S. Cl. CPC A23L 2/39; A23L 2/66; A23L 25/30; A23L 33/155; A23L 33/16; A23V 2002/00; A23L 33/19; A23L 33/18; A23L 33/22; A23L 33/24; A23L 2/60; A23L 33/185

(57) ABSTRACT

The present invention relates to the food industry, more particularly to technologies of production of dietary supplements (DS).

The object of the present invention is to provide a biological alternative for the whole modern human nutrition.

The object of the present invention is to provide a concentrate for preparation of a cocktail having an increased content of protein and lowered caloricity comprising only natural ingredients.

The technical effect is to increase the shelf life, reduce the allergenic capacity (hypoallergenic characteristics) and increase the range of protein DSs.

The object and the technical effect mentioned above is achieved with the aid of a dry concentrate for preparation of a protein cocktail containing a nut press-cake of nuciculture, a protein source, inuline, a source of soluble fibers, wherein said concentrate also includes a source of insoluble fibers, a vitamin premix, a mineral premix, an antioxidant and at least one auxiliary component, wherein the antioxidant is homogeneously pre-distributed over the particles of the nut press-cake.

The present invention relates to the food industry, more particularly to technologies of production of dietary supplements (DS).

The object of the present invention is to provide a biological alternative for the whole modern human nutrition. The present invention can be used as DSs to substitute, partially or completely, one or more meals for weight loss (as part of a diet), as a protein source or as a digestion improver.

Today, the food industry is flooded with products containing fat replacers (trans fats, fatty acids formed during oil refining, etc.), flavor enhancers and other supplements. Quite often these supplements are allergens and can cause digestive and metabolic disorders that directly affect the health and related quality of life.

That is why there is an urgent need to provide a concentrate for preparation of a cocktail which would address all the main problems of a human modern nutrition:
Natural origin (a product contains only natural ingredients),
Hypoallergenic characteristics,
Functionality (balanced formulation: proteins, fats, carbohydrates, and nutrients).

It is known from the art (RU Patent 2468609, publ. Oct. 12, 2012, IPC A23L1/30, A23L1/302, A23L1/305, A23L1/36) the protein-vitaminic product for sports nutrition, characterized in that it comprises the cedar nut press-cake, pumpkin-seed meal, ground wheat germs and cracked sunflower seed kernels, the dried fruit mixture containing dried and ground rose hips, dried and ground cranberries, dried and ground cowberries used in the following ratio 2.5:1:1, respectively, ascorbic acid and fructose. Said mixture is heat treated by the vacuum drying method at a temperature between 35-40° C. and is characterized in that it contains glutamine from 3.5 to 4.2%, leucine from 2.5 to 3.0%, alanine from 2.3 to 2.8%, arginine from 1.7 to 2.0%, isoleucine from 1.0 to 1.3%, vitamin E from 17 to 21 mg %, folic acid from 2.2 to 2.7 mg %, and said components are used at the following ratio, wt. %:

| | |
|---|---|
| the cedar nut press-cake | 38.60-50.00, |
| the pumpkin-seed meal | 5.00-6.00, |
| ground wheat germs | 9.00-13.00, |
| cracked sunflower seed kernels | 9.00-13.00, |
| the dried fruit mixture | 19.91-23.32, |
| fructose | 7-9, |
| ascorbic acid | 0.08-0.09. |

Also, it is known from the art (RU Patent 2438343, publ. Oct. 1, 2012, IPC A23J3/00, A23L2/39) the dry protein mixture for preparation of a cocktail for pregnant and breastfeeding women, containing protein, carbohydrates, dietary fibers, vitamin and mineral premixes and other dietary supplements. In addition, the mixture comprises taurine, soy protein isolate as a source of protein source, the sugar and maltodextrin mixture as a carbohydrate source, where taurine, sugar and maltodextrin ratio is 1:600:250-1:650:300 with the following component ratio, wt. %

| | |
|---|---|
| soy protein isolate | 65.0-70.0, |
| dietary fibers | 1.0-3.0, |
| the sugar and maltodextrin mixture | 25.5-28.5, |
| the vitamin premix | 0.4-0.5, |
| the mineral premix | 0.3-0.4 |
| taurine | 0.3, |
| other dietary supplements | the rest. |

There are known from the art (the website of Russian LLC “Delfa” (see http://www.delfa-siberiasu/produktsiya/deserty/item/306-kedrovyj-desert-chjornaya-smorodina and http://www.delfa-siberiasu/produktsiya/deserty/item/305-kedrovyj-desert-lesnaya-yagoda) healthy nutrition products “Cedar dessert ‘Blackcurrant’” («Kedrovyj desert «Chjornaya smorodina») and “Cedar dessert ‘Forest Berry’” («Kedrovyj desert «Lesnaya yagoda») which caloric value is no more than 310 kcal per 100 g. Said products are used to make a cocktail (a beverage) by mixing 25 g of the powdered product (3 tablespoons) in 200 ml of water or milk. The “Cedar dessert ‘Blackcurrant’” and “Cedar dessert ‘Forest Berry’” products include: cedar nut press-cake, almond press-cake, sesame seed press-cake, dry demineralized whey, milk powder, inuline, guar gum, dried ground berries, dried ground apple, a sweetener, a flavor, succinic acid.

The closest to the present invention by the number of the essential features are healthy nutrition products “Cedar dessert ‘Blackcurrant’” and “Cedar dessert ‘Forest Berry’”. These products have been selected as a prototype of the present invention.

The prototype drawbacks include:
increased allergenic capacity (due to the milk powder and flavors in the formulation),
insufficient shelf life (due to the quick oxidation of the nut press-cake),
the no vitamin-mineral complex in the formulation.

The object of the present invention is to provide a concentrate for preparation of a cocktail having an increased content of protein and lowered caloricity comprising only natural ingredients.

The technical effect is to increase the shelf life, reduce the allergenic capacity (hypoallergenic characteristics) and increase the range of protein DSs for weight loss.

The object and the technical effect mentioned above is achieved with the aid of a dry concentrate for preparation of a protein cocktail containing a nut press-cake of nuciculture, a protein source, inuline, a source of soluble fibers, wherein said concentrate also includes a source of insoluble fibers, a vitamin premix, a mineral premix, an antioxidant and at least one auxiliary component, contained at the following ratio, wt. %:

| | |
|---|---|
| the nut press-cake | from 0.4 to 93.85, |
| the protein source | from 1.0 to 94.45, |
| the source of soluble fibers | from 1.0 to 30.0, |
| the source of insoluble fibers | from 1.0 to 70.0, |
| the vitamin premix | from 0.1 to 5.0, |
| the mineral premix | from 0.1 to 5.0, |
| the antioxidant | from 0.05 to 0.5, |
| auxiliary components | from 2.5 to 25.0, |

wherein the antioxidant is homogeneously pre-distributed over the particles of the nut press-cake.

According to the preferred embodiments, said technical effect can also be achieved by that:
the following concentrate comprises the components at the following ratio, wt. %:

| | |
|---|---|
| the nut press-cake | from 5.0 to 50.0, |
| the protein source | from 30.0 to 65.0, |
| the source of soluble fibers | from 1.0 to 15.0, |
| the source of insoluble fibers | from 1.0 to 50.0, |
| the vitamin premix | from 0.1 to 1.0, |
| the mineral premix | from 0.1 to 1.0, |
| the antioxidant | from 0.05 to 0.3, |
| auxiliary components | from 2.5 to 10.0, |

the following concentrate comprises the components at the following ratio, wt. %:

| | |
|---|---|
| the nut press-cake | from 5.0 to 35.0, |
| the protein source | from 30.0 to 40.0, |
| the source of soluble fibers | from 5.0 to 10.0, |
| the source of insoluble fibers | from 10.0 to 20.0, |
| the vitamin premix | from 0.1 to 0.5, |
| the mineral premix | from 0.1 to 0.5, |
| the antioxidant | from 0.1 to 0.25, |
| auxiliary components | from 3.0 to 5.0, |

the nut press-cake is selected from the group including cedar nut press-cake, peanut press-cake, almond press-cake, walnut press-cake, hazelnut press-cake, cashew press-cake, brazil nut press-cake, water chestnut (sanghara-nut, or ling) press-cake, pecan press-cake, pistachio press-cake, macadamia press-cake, or a mixture of two or more of said press-cakes,
the nut press-cake is produced by the cold pressing method,
the protein source is selected from the group including milk protein hydrolysate, lactose-free whey protein isolate, soy protein isolate, soy protein concentrate, pea protein isolate, pea protein isolate, protein isolate of sunflower kernels, protein concentrate of sunflower kernels, amaranth protein isolate, amaranth protein concentrate, bean protein isolate, bean protein concentrate, chickpea protein isolate, chickpea protein concentrate, Chorella algae, chorella protein isolate, chorella protein concentrate,
the source of soluble fibers is selected from the group including inuline, gluten-free apple fibers, xanthan gum, guar gum, konjac gum, apple pectin or a mixture of two or more of said sources of soluble fibers;
the source of insoluble fibers is selected from the group including microcrystalline cellulose, chitin, chitosan, lignin, hemicellulose, bran of Plantago psyllium seeds, wheat bran, rye bran, barley bran, rice bran, soy bran, buckwheat bran, linseed bran, fruit fibers, or a mixture of two or more of said sources of insoluble fibers,
the antioxidant is selected from the group including ascorbyl palmitate, ascorbyl stearate, and tocopherol, rosemary natural extract,
the antioxidant is homogeneously pre-distributed over the particles of the nut press-cake,
as the vitamin premix a set of vitamins and/or vitamin-like substances is used selected from the group including vitamin A, vitamin B₁, vitamin B₂, vitamin B₃, vitamin B₄ (choline), vitamin B₅, vitamin B₆, vitamin B₈ (inositol), vitamin B₉, vitamin B₁₂, vitamin B₁₃ (orotic acid), vitamin C, vitamin D₃, vitamin E, vitamin H (biotin), vitamin K,
as the mineral premix a set of mineral substances is used selected from the group including mineral substances, comprising iron, iodine, potassium, calcium, magnesium, manganese, copper, selenium, zinc, phosphorus, molybdenum, chromium (III), silicon, cobalt, fluorine, vanadium, boron, silver,
at least one auxiliary component is selected from the group including a sweetener, a natural hypoallergenic flavor, an anticaking agent, an acidity regulator,
the sweetener is selected from the group including aspartame, acesulfame potassium, aspartame-acesulfame salt, isomalt, xylitol, lactitol, maltitol, mannitol, neohesperidin dihydrochalcon, saccharin and the salts thereof, sorbitol, sucralose, stevia, stevia leaf extract, stevioside, thaumatin, cyclamic acid and the salts thereof, erythritol,
as the natural hypoallergenic flavor a natural flavor “green apple” is used,
the anticaking agent is selected from the group including amorphous silicon dioxide, talc, calcium carbonate, carbonates of magnesium, aluminum salts of fatty acids, ammonium salts of fatty acids, potassium salts of fatty acids, calcium salts of fatty acids, magnesium salts of fatty acids, sodium salts of fatty acids, magnesium oxide, calcium silicate, magnesium silicates, aluminosilicates of sodium, calcium, potassium, bentonite, kaolin,
fatty acids are selected from the group including myristic acid, oleic acid, palmitic acid, stearic acid or the mixtures thereof,
the acidity regulator is selected from the group including potassium citrate, potassium acetate, sodium acetate, calcium acetate, potassium lactate, calcium lactate, magnesium lactate, sodium citrate, potassium citrate, calcium citrate, sodium tartrate, potassium tartrate, sodium-potassium tartrate, calcium tartrate, sodium phosphates, potassium phosphates, calcium phosphates, magnesium phosphates, sodium malate, potassium malate, calcium malate, sodium fumarate,
a caloric value of said concentrate is no more than 310 kcal per 100 g,
a mass fraction of fats in the concentrate is no more than 15wt. %, wherein a mass fraction of polyunsaturated fatty acids of fats in said concentrate is from 5 to 10 wt. %, and a mass fraction of phospholipids in said concentrate is from 1.05 to 15.0 wt. %,
a mass fraction of carbohydrates in said concentrate is no more than 10 wt. %,
a mass fraction of protein in said concentrate is no less than 40 wt. %, and that of highly digestible protein is from 40 to 95 wt. %;
the nut press-cake is mixed with the antioxidant until the antioxidant is completely distributed over the mixture.

Also, the object and the technical effect mentioned above are achieved with the aid of a protein cocktail produced from the mentioned concentrate by mixing the concentrate with a required amount of a liquid food product.

According to the preferred embodiments, said technical effect is further achieved by that the liquid food product is selected from the group including potable water, milk, defatted kefir, defatted yogurt, fruit juice, vegetable juice.

The formulation of the composition has theoretical backgrounds. All the components included in the composition formulation are approved for use within DS. The balanced combination of ingredients and the way how they interact, contributes to the achievement of the technical effects.

It is recommended to use the concentrate according to the invention as a DS, i.e., as a source of protein, dietary fibers, inuline, phospholipids, polyunsaturated fatty acids, including OMEGA-6, as a further source of vitamins and minerals and as a perfect food substitute (for one or more meals), as an agent for weight loss (as a part of a diet), as a digestion improver (prebiotic activity due to the presence of inuline and various dietary fibers).

The following operations are required to produce the concentrate:
adding the whole nut press-cake,
adding the antioxidant into the mixture with the nut press-cake prior the operation of co-milling,
milling the nut press-cake together with the antioxidant prior to the homogeneous distribution of the antioxidant over the particles of the press-cake (to avoid the oxidative deterioration of fats in the nut press-cake),
dry mixing the nut press-cake with the antioxidant and other ingredients.

The nut press-cake is milled together with the antioxidant (prior to the homogeneous distribution of the antioxidant over the particles of the press-cake) by the following method. A weighted amount of the nut press-cake of nuciculture loaded into a mixer with a respective amount of the antioxidant and then all the ingredients are mixed together until the antioxidant is fully distributed over the mixture, meanwhile controlling the impregnation of the antioxidant by the press-cake particles. The impregnation control is performed on press-cake samples taken during mixing which are sectioned and evaluated for the degree of the antioxidant penetration into the particles which is assessed by the way how the color changes from the particle surface towards the particle inside. The mixing is stopped if the impregnation beginning test exhibits the positive outcome which indicates that the antioxidant has covered the 100% of the particle surface.

To prevent metal particles from entering the product, the required weighted amounts of ingredients must be sieved and passed through magnetic traps. Then, they are loaded into the mixer (of different types) with the inert atmosphere inside, and the milled cedar nut press-cake is added thereto after the addition of the antioxidant and milling in the inert atmosphere. The ingredients are mixed together to produce a homogeneous mass, the mixture is sieved, passed through the magnetic trap and transferred for packing into a retail packaging.

The following are examples of embodiments of the invention which, however, do not represent all possible embodiments and shall not be considered as limiting the present invention.

### EXAMPLES OF THE EMBODIMENTS

### Example 1

10.00 kg of the cedar nut press-cake, 0.50 kg of ascorbyl palmitate and 0.168 kg of tocopherol oil solution (50% d1-alpha Tocopherol acetate in oil) are loaded into the mixer and are mixed until antioxidants are fully distributed in the mixture, meanwhile controlling the impregnation of the antioxidant by the press-cake particles. The impregnation control is performed on press-cake samples taken during mixing which are sectioned and evaluated for the degree of the antioxidant penetration into the particles which is assessed by the way how the color changes from the particle surface towards the particle inside. The mixing is stopped if the impregnation beginning test exhibits the positive outcome. The antioxidant-treated press-cake is rolledout (in the roll crusher DV 300 with smooth rollers and the gap between rollers of 0.5 mm) to stimulate impregnation.

The press-cake treated with the antioxidant is compounded with 48.70 kg of lactose-free whey protein isolate, 1.5 kg of inuline, 20.62 kg of microcrystalline cellulose, 15.00 kg of (gluten-free) apple fibers, 0.333 kg of xanthan gum, 0.333 kg of guar gum, 0.333 kg of konjac gum, 0.333 kg of apple pectin, 0.814 kg of potassium citrate, 0.5 kg of amorphous silicon dioxide, 0.033 kg of sucralose, 0.167 kg of natural apple flavor, 0.333 kg of vitamin premix (containing the following vitamins [in the forms approved for use in food and pharmaceutical industries, in wt. % of a premix mass]: A (0.35 wt. %), B₁ (0.61 wt. %), B₂ (0.714 wt. %), B₆ (0.714 wt. %), B₁₂ (0.001 wt. %), PP (7.14 wt. %), folic acid (0.143 wt. %), pantothenic acid (1.78 wt. %), biotin (0.018 wt. %), E (5.35 wt. %), D₃ (0.0017 wt. %), 0.333 kg of mineral premix (containing the following minerals [in the forms approved for use in food and pharmaceutical industries, in wt. % of a premix mass]: calcium (16 wt. %), magnesium (11.6 wt. %), potassium (11.6 wt. %), iron (4.6 wt. %), zinc (2.84 wt. %), iodine (0.043 wt. %), selenium (0.0137 wt. %), copper (0.38 wt. %), manganese (0.3 wt. %)), and all the components are mixed until the components are homogeneous distributed.

Next, the resulted mixture is transferred for milling. The mill crusher 40-V (China), 60 kg/h, main shaft revolutions 3400 min⁻¹. The operation is performed twice, the final particle size is no more than 50 mesh. The milled, homogenized and dry mixture passes through the magnetic separator (with rod diameters of 22 mm and the magnetic intensity at the rod surface of 1 T), which prevents metal particles from being penetrated into the product, and is transferred for packing into a retail packaging, the packing is performed in the nitrogen atmosphere at the pressure of 1.0 atm.

### Example 2

The mixer is loaded with 94.685 kg of lactose-free whey protein isolate, 1.5 kg of inuline, 0.1 kg of microcrystalline cellulose, 0.1 kg of (gluten-free) apple fibers, 0.333 kg of xanthan gum, 0.333 kg of guar gum, 0.333 kg of konjac gum, 0.333 kg of apple pectin, 0.814 kg of potassium citrate, 0.5 kg of amorphous silicon dioxide, 0.033 kg of sucralose, 0.167 kg of natural apple flavor, 0.333 kg of vitamin premix (containing the following vitamins [in the forms approved for use in food and pharmaceutical industries]: A (0.35 wt. %), B₁ (0.61 wt. %), B₂ (0.714 wt. %), B₆ (0.714 wt. %), B₁₂ (0.001 wt. %), PP (7.14 wt. %), folic acid (0.143 wt. %), pantothenic acid (1.78 wt. %), biotin (0.018 wt. %), E (5.35 wt. %), D₃ (0.0017 mg/100 mg), 0.333 kg of mineral premix (containing the following minerals [in the forms approved for use in food and pharmaceutical industries]: calcium (16 wt. %), magnesium (11.6 wt. %), potassium (11.6 wt. %), iron (4.6 wt. %), zinc (2.84 wt. %), iodine (0.043 wt. %), selenium (0.0137 wt. %), copper (0.38 wt. %), manganese (0.3 wt. %)), and all the components are mixed until the components are homogeneous distributed (Mixture 1).

The mixer is loaded with 0.1 kg of cedar nut press-cake, 0.0016 kg of ascorbyl palmitate, 0.00053 kg (0.53 g) of tocopherol oil solution (50% d1-alpha Tocopherol acetate in oil), and the antioxidant is applied as shown in Example 1 (Mixture 2).

Next, the resulted Mixture 2 is transferred for milling:

the mill CM-01-H-145, 5 kg/h, main shaft revolutions are 350 min⁻¹. The operation is performed twice, the final particle size is no more than 50 mesh.

Then, Mixture 1 and Mixture 2 are combined and mixed together until the components are homogeneously distributed.

The homogenized and dry mixture passes through the magnetic separator (with rod diameters of 22 mm and the magnetic intensity at the rod surface of 1 T), which prevents metal particles from being penetrated into the product, and is transferred for packing into a retail packaging, the packing is performed in the nitrogen atmosphere at the pressure of 1.0 atm.

### Example 3

The mixer is loaded with 94.02 kg of cedar nut press-cake, 0.50 kg of ascorbyl palmitate, 0.168 kg of tocopherol oil solution (50% d1-alpha Tocopherol acetate in oil), and the antioxidant is applied as shown in Example 1.

The press-cake treated with the antioxidant is compounded with 0.1 kg of lactose-free whey protein isolate, 1.5 kg of inuline, 0.1 kg of microcrystalline cellulose, 0.1 kg of (gluten-free) apple fibers, 0.333 kg of xanthan gum, 0.333 kg of guar gum, 0.333 kg of konjac gum, 0.333 kg of apple pectin, 0.814 kg of potassium citrate, 0.5 kg of amorphous silicon dioxide, 0.033 kg of sucralose, 0.167 kg of natural apple flavor, 0.333 kg of vitamin premix (containing the following vitamins [in the forms approved for use in food and pharmaceutical industries]: A (0.35 wt. %), B₁ (0.61 wt. %), B₂ (0.714 wt. %), B₆ (0.714 wt. %), B₁₂ (0.001 wt. %), PP (7.14 wt. %), folic acid (0.143 wt. %), pantothenic acid (1.78 wt. %), biotin (0.018 wt. %), E (5.35 wt. %), D₃ (0.0017 mg/100 mg), 0.333 kg of mineral premix (containing the following minerals [in the forms approved for use in food and pharmaceutical industries]: calcium (16 wt. %), magnesium (11.6 wt. %), potassium (11.6 wt. %), iron (4.6 wt. %), zinc (2.84 wt. %), iodine (0.043 wt. %), selenium (0.0137 wt. %), copper (0.38 wt. %), manganese (0.3 wt. %)), and all the components are mixed until the components are homogeneous distributed.

Next, the resulted mixture is transferred for milling

The mill crusher 40-V (China), 60 kg/h, main shaft revolutions 3400 min⁻¹. The operation is performed twice, the final particle size is no more than 50 mesh.

The milled, homogenized and dry mixture passes through the magnetic separator (with rod diameters of 22 mm and the magnetic intensity at the rod surface of 1 T), which prevents metal particles from being penetrated into the product, and is transferred for packing into a retail packaging, the packing is performed in the nitrogen atmosphere at the pressure of 1.0 atm.

### Example 4

The mixer is loaded with 10.00 kg of cedar nut press-cake, 0.50 kg of ascorbyl palmitate, 0.168 kg of tocopherol oil solution (50% d1-alpha Tocopherol acetate in oil), and the antioxidant is applied as shown in Example 1.

The press-cake treated with the antioxidant is compounded with 48.70 kg of lactose-free whey protein isolate, 1.5 kg of inuline, 26.186 kg of microcrystalline cellulose, 15.00 kg of (gluten-free) apple fibers, 0.333 kg of xanthan gum, 0.333 kg of guar gum, 0.333 kg of konjac gum, 0.333 kg of apple pectin, 0.814 kg of potassium citrate, 0.5 kg of amorphous silicon dioxide, 0.033 kg of sucralose, 0.167 kg of natural apple flavor, 0.05 kg of vitamin premix (containing the following vitamins [in the forms approved for use in food and pharmaceutical industries]: A (0.35 wt. %), B₁ (0.61 wt. %), B₂ (0.714 wt. %), B₆ (0.714 wt. %), B₁₂ (0.001 wt. %), PP (7.14 wt. %), folic acid (0.143 wt. %), pantothenic acid (1.78 wt. %), biotin (0.018 wt. %), E (5.35 wt. %), D₃ (0.0017 wt. %), 0.05 kg of mineral premix (containing the following minerals [in the forms approved for use in food and pharmaceutical industries]: calcium (16 wt. %), magnesium (11.6 wt. %), potassium (11.6 wt. %), iron (4.6 wt. %), zinc (2.84 wt. %), iodine (0.043 wt. %), selenium (0.0137 wt. %), copper (0.38 wt. %), manganese (0.3 wt. %)), and all the components are mixed until the components are homogeneous distributed.

Next, the resulted mixture is transferred for milling.

The mill crusher 40-V (China), 60 kg/h, main shaft revolutions 3400 min⁻¹. The operation is performed twice, the final particle size is no more than 50 mesh.

The milled, homogenized and dry mixture passes through the magnetic separator (with rod diameters of 22 mm and the magnetic intensity at the rod surface of 1 T), which prevents metal particles from being penetrated into the product, and is transferred for packing into a retail packaging, the packing is performed in the nitrogen atmosphere at the pressure of 1.0 atm.

### Example 5

The mixer is loaded with 10.00 kg of cedar nut press-cake, 0.50 kg of ascorbyl palmitate, 0.168 kg of tocopherol oil solution (50% d1-alpha Tocopherol acetate in oil), and the antioxidant is applied as shown in Example 1.

The press-cake treated with the antioxidant is compounded with 48.70 kg of lactose-free whey protein isolate, 1.5 kg of inuline, 20.62 kg of microcrystalline cellulose, 15.00 kg of (gluten-free) apple fibers, 0.333 kg of xanthan gum, 0.333 kg of guar gum, 0.333 kg of konjac gum, 0.333 kg of apple pectin, 0.814 kg of potassium citrate, 0.5 kg of amorphous silicon dioxide, 0.033 kg of sucralose, 0.167 kg of natural apple flavor, 0.333 kg of vitamin premix (containing the following vitamins [in the forms approved for use in food and pharmaceutical industries]: A (0.35 wt. %), B₁ (0.61 wt. %), B₂ (0.714 wt. %), B₆ (0.714 wt. %), B₁₂ (0.001 wt. %), PP (7.14 wt. %), folic acid (0.143 wt. %), pantothenic acid (1.78 wt. %), biotin (0.018 wt. %), E (5.35 wt. %), D₃ (0.0017 mg/100 mg), 0.333 kg of mineral premix (containing the following minerals [in the forms approved for use in food and pharmaceutical industries]: calcium (16 wt. %), magnesium (11.6 wt. %), potassium (11.6 wt. %), iron (4.6 wt. %), zinc (2.84 wt. %), iodine (0.043 wt. %), selenium (0.0137 wt. %), copper (0.38 wt. %), manganese (0.3 wt. %)), and all the components are mixed until the components are homogeneous distributed.

Next, the resulted mixture is transferred for milling.

The mill crusher 40-V (China), 60 kg/h, main shaft revolutions 3400 min⁻¹. The operation is performed twice, the final particle size is no more than 50 mesh.

The milled, homogenized and dry mixture passes through the magnetic separator (with rod diameters of 22 mm and the magnetic intensity at the rod surface of 1 T), which prevents metal particles from being penetrated into the product, and is transferred for packing into a retail packaging, the packing is performed in the nitrogen atmosphere at the pressure of 1.0 atm.

### Example 6

The mixer is loaded with 10.00 kg of cedar nut press-cake, 0.50 kg of ascorbyl palmitate, 0.168 kg of tocopherol oil solution (50% d1-alpha Tocopherol acetate in oil), and the antioxidant is applied as shown in Example 1.

The press-cake treated with the antioxidant is compounded with 48.70 kg of lactose-free whey protein isolate, 1.5 kg of inuline, 14.9 kg of microcrystalline cellulose, 15.00 kg of (gluten-free) apple fibers, 0.333 kg of xanthan gum, 0.333 kg of guar gum, 0.333 kg of konjac gum, 0.333 kg of apple pectin, 0.814 kg of potassium citrate, 0.5 kg of amorphous silicon dioxide, 0.033 kg of sucralose, 0.167 kg of natural apple flavor, 2.86 kg of vitamin premix (containing the following vitamins [in the forms approved for use in food and pharmaceutical industries]: A (0.35 wt. %), B₁ (0.61 wt. %), B₂ (0.714 wt. %), B₆ (0.714 wt. %), B₁₂ (0.001 wt. %), PP (7.14 wt. %), folic acid (0.143 wt. %), pantothenic acid (1.78 wt. %), biotin (0.018 wt. %), E (5.35 wt. %), D₃ (0.0017 mg/100 mg), 2.86 kg of mineral premix (containing the following minerals [in the forms approved for use in food and pharmaceutical industries]: calcium (16 wt. %), magnesium (11.6 wt. %), potassium (11.6 wt. %), iron (4.6 wt. %), zinc (2.84 wt. %), iodine (0.043 wt. %), selenium (0.0137 wt. %), copper (0.38 wt. %), manganese (0.3 wt. %)), and all the components are mixed until the components are homogeneous distributed.

Next, the resulted mixture is transferred for milling.

The mill crusher 40-V (China), 60 kg/h, main shaft revolutions 3400 min⁻¹. The operation is performed twice, the final particle size is no more than 50 mesh.

The milled, homogenized and dry mixture passes through the magnetic separator (with rod diameters of 22 mm and the magnetic intensity at the rod surface of 1 T), which prevents metal particles from being penetrated into the product, and is transferred for packing into a retail packaging, the packing is performed in the nitrogen atmosphere at the pressure of 1.0 atm.

### Example 7

The mixer is loaded with 10.00 kg of cedar nut press-cake, 0.50 kg of ascorbyl palmitate, 0.168 kg of tocopherol oil solution (50% d1-alpha Tocopherol acetate in oil), and the antioxidant is applied as shown in Example 1.

The press-cake treated with the antioxidant is compounded with 48.70 kg of lactose-free whey protein isolate, 0.1 kg of inuline, 22.02 kg of microcrystalline cellulose, 15.00 kg of (gluten-free) apple fibers, 0.333 kg of xanthan gum, 0.333 kg of guar gum, 0.333 kg of konjac gum, 0.333 kg of apple pectin, 0.814 kg of potassium citrate, 0.5 kg of amorphous silicon dioxide, 0.033 kg of sucralose, 0.167 kg of natural apple flavor, 0.333 kg of vitamin premix (containing the following vitamins [in the forms approved for use in food and pharmaceutical industries]: A (0.35 wt. %), B₁ (0.61 wt. %), B₂ (0.714 wt. %), B₆ (0.714 wt. %), B₁₂ (0.001 wt. %), PP (7.14 wt. %), folic acid (0.143 wt. %), pantothenic acid (1.78 wt. %), biotin (0.018 wt. %), E (5.35 wt. %), D₃ (0.0017 mg/100 mg), 0.333 kg of mineral premix (containing the following minerals [in the forms approved for use in food and pharmaceutical industries]: calcium (16 wt. %), magnesium (11.6 wt. %), potassium (11.6 wt. %), iron (4.6 wt. %), zinc (2.84 wt. %), iodine (0.043 wt. %), selenium (0.0137 wt. %), copper (0.38 wt. %), manganese (0.3 wt. %)), and all the components are mixed until the components are homogeneous distributed.

Next, the resulted mixture is transferred for milling.

The mill crusher 40-V (China), 60 kg/h, main shaft revolutions 3400 min⁻¹. The operation is performed twice, the final particle size is no more than 50 mesh.

The milled, homogenized and dry mixture passes through the magnetic separator (with rod diameters of 22 mm and the magnetic intensity at the rod surface of 1 T), which prevents metal particles from being penetrated into the product, and is transferred for packing into a retail packaging, the packing is performed in the nitrogen atmosphere at the pressure of 1.0 atm.

### Example 8

The mixer is loaded with 10.00 kg of cedar nut press-cake, 0.50 kg of ascorbyl palmitate, 0.168 kg of tocopherol oil solution (50% d1-alpha Tocopherol acetate in oil), and the antioxidant is applied as shown in Example 1.

The press-cake treated with the antioxidant is compounded with 48.70 kg of lactose-free whey protein isolate, 8.333 kg of inuline, 13.787 kg of microcrystalline cellulose, 15.00 kg of (gluten-free) apple fibers, 0.333 kg of xanthan gum, 0.333 kg of guar gum, 0.333 kg of konjac gum, 0.333 kg of apple pectin, 0.814 kg of potassium citrate, 0.5 kg of amorphous silicon dioxide, 0.033 kg of sucralose, 0.167 kg of natural apple flavor, 0.333 kg of vitamin premix (containing the following vitamins [in the forms approved for use in food and pharmaceutical industries]: A (0.35 wt. %), B₁ (0.61 wt. %), B₂ (0.714 wt. %), B₆ (0.714 wt. %), B₁₂ (0.001 wt. %), PP (7.14 wt. %), folic acid (0.143 wt. %), pantothenic acid (1.78 wt. %), biotin (0.018 wt. %), E (5.35 wt. %), D₃ (0.0017 mg/100 mg), 0.333 kg of mineral premix (containing the following minerals [in the forms approved for use in food and pharmaceutical industries]: calcium (16 wt. %), magnesium (11.6 wt. %), potassium (11.6 wt. %), iron (4.6 wt. %), zinc (2.84 wt. %), iodine (0.043 wt. %), selenium (0.0137 wt. %), copper (0.38 wt. %), manganese (0.3 wt. %)), and all the components are mixed until the components are homogeneous distributed.

Next, the resulted mixture is transferred for milling.

The mill crusher 40-V (China), 60 kg/h, main shaft revolutions 3400 min⁻¹. The operation is performed twice, the final particle size is no more than 50 mesh.

The milled, homogenized and dry mixture passes through the magnetic separator (with rod diameters of 22 mm and the magnetic intensity at the rod surface of 1 T), which prevents metal particles from being penetrated into the product, and is transferred for packing into a retail packaging, the packing is performed in the nitrogen atmosphere at the pressure of 1.0 atm.

### Example 9

The mixer is loaded with 10.00 kg of cedar nut press-cake, 0.50 kg of ascorbyl palmitate, 0.168 kg of tocopherol oil solution (50% d1-alpha Tocopherol acetate in oil), and the antioxidant is applied as shown in Example 1.

The press-cake treated with the antioxidant is compounded with 54.22 kg of lactose-free whey protein isolate, 1.5 kg of inuline, 0.1 kg of microcrystalline cellulose, 30.00 kg of (gluten-free) apple fibers, 0.333 kg of xanthan gum, 0.333 kg of guar gum, 0.333 kg of konjac gum, 0.333 kg of apple pectin, 0.814 kg of potassium citrate, 0.5 kg of amorphous silicon dioxide, 0.033 kg of sucralose, 0.167 kg of natural apple flavor, 0.333 kg of vitamin premix (containing the following vitamins [in the forms approved for use in food and pharmaceutical industries]: A (0.35 wt. %), B₁ (0.61 wt. %), B₂ (0.714 wt. %), B₆ (0.714 wt. %), B₁₂ (0.001 wt. %), PP (7.14 wt. %), folic acid (0.143 wt. %), pantothenic acid (1.78 wt. %), biotin (0.018 wt. %), E (5.35 wt. %), D₃ (0.0017 mg/100 mg), 0.333 kg of mineral premix (containing the following minerals [in the forms approved for use in food and pharmaceutical industries]: calcium (16 wt. %), magnesium (11.6 wt. %), potassium (11.6 wt. %), iron (4.6 wt. %), zinc (2.84 wt. %), iodine (0.043 wt. %), selenium (0.0137 wt. %), copper (0.38 wt. %), manganese (0.3 wt. %)), and all the components are mixed until the components are homogeneous distributed.

Next, the resulted mixture is transferred for milling.

The mill crusher 40-V (China), 60 kg/h, main shaft revolutions 3400 min⁻¹. The operation is performed twice, the final particle size is no more than 50 mesh.

The milled, homogenized and dry mixture passes through the magnetic separator (with rod diameters of 22 mm and the magnetic intensity at the rod surface of 1 T), which prevents metal particles from being penetrated into the product, and is transferred for packing into a retail packaging, the packing is performed in the nitrogen atmosphere at the pressure of 1.0 atm.

### Example 10

The mixer is loaded with 10.00 kg of cedar nut press-cake, 0.50 kg of ascorbyl palmitate, 0.168 kg of tocopherol oil solution (50% d1-alpha Tocopherol acetate in oil), and the antioxidant is applied as shown in Example 1.

The press-cake treated with the antioxidant is compounded with 48.70 kg of lactose-free whey protein isolate, 1.5 kg of inuline, 35.52 kg of microcrystalline cellulose, 0.1 kg of (gluten-free) apple fibers, 0.333 kg of xanthan gum, 0.333 kg of guar gum, 0.333 kg of konjac gum, 0.333 kg of apple pectin, 0.814 kg of potassium citrate, 0.5 kg of amorphous silicon dioxide, 0.033 kg of sucralose, 0.167 kg of natural apple flavor, 0.333 kg of vitamin premix (containing the following vitamins [in the forms approved for use in food and pharmaceutical industries]: A (0.35 wt. %), B₁ (0.61 wt. %), B₂ (0.714 wt. %), B₆ (0.714 wt. %), B₁₂ (0.001 wt. %), PP (7.14 wt. %), folic acid (0.143 wt. %), pantothenic acid (1.78 wt. %), biotin (0.018 wt. %), E (5.35 wt. %), D₃ (0.0017 mg/100 mg), 0.333 kg of mineral premix (containing the following minerals [in the forms approved for use in food and pharmaceutical industries]: calcium (16 wt. %), magnesium (11.6 wt. %), potassium (11.6 wt. %), iron (4.6 wt. %), zinc (2.84 wt. %), iodine (0.043 wt. %), selenium (0.0137 wt. %), copper (0.38 wt. %), manganese (0.3 wt. %)), and all the components are mixed until the components are homogeneous distributed.

Next, the resulted mixture is transferred for milling.

The mill crusher 40-V, 60 kg/h, main shaft revolutions 3400 min⁻¹. The operation is performed twice, the final particle size is no more than 50 mesh.

The milled, homogenized and dry mixture passes through the magnetic separator (with rod diameters of 22 mm and the magnetic intensity at the rod surface of 1 T), which prevents metal particles from being penetrated into the product, and is transferred for packing into a retail packaging, the packing is performed in the nitrogen atmosphere at the pressure of 1.0 atm.

### Example 11

The mixer is loaded with 93.85 kg of cedar nut press-cake, 0.50 kg of ascorbyl palmitate, 0.168 kg of tocopherol oil solution (50% d1-alpha Tocopherol acetate in oil), and the antioxidant is applied as shown in Example 1.

The press-cake treated with the antioxidant is compounded with 1.0 kg of lactose-free whey protein isolate, 0.97 kg of inuline, 1.0 kg of microcrystalline cellulose, 1.0 kg of (gluten-free) apple fibers, 0.1 kg of xanthan gum, 0.1 kg of guar gum, 0.1 kg of konjac gum, 0.1 kg of apple pectin, 0.412 kg of potassium citrate, 0.3 kg of amorphous silicon dioxide, 0.033 kg of sucralose, 0.167 kg of natural flavor “green apple”, 0.1 kg of vitamin premix (containing the following vitamins [in the forms approved for use in food and pharmaceutical industries, in wt. % of a premix mass]: A (0.35 wt. %), B₁ (0.61 wt. %), B₂ (0.714 wt. %), B₆ (0.714 wt. %), B₁₂ (0.001 wt. %), PP (7.14 wt. %), folic acid (0.143 wt. %), pantothenic acid (1.78 wt. %), biotin (0.018 wt. %), E (5.35 wt. %), D₃ (0.0017 wt. %), 0.1 kg of mineral premix (containing the following minerals [in the forms approved for use in food and pharmaceutical industries, in wt. % of a premix mass]: calcium (16 wt. %), magnesium (11.6 wt. %), potassium (11.6 wt. %), iron (4.6 wt. %), zinc (2.84 wt. %), iodine (0.043 wt. %), selenium (0.0137 wt. %), copper (0.38 wt. %), manganese (0.3 wt. %)), and all the components are mixed until the components are homogeneous distributed.

Next, the resulted mixture is transferred for milling. The mill crusher 40-V (China), 60 kg/h, main shaft revolutions 3400 min⁻¹. The operation is performed twice, the final particle size is no more than 50 mesh.

The milled, homogenized and dry mixture passes through the magnetic separator (with rod diameters of 22 mm and the magnetic intensity at the rod surface of 1 T), which prevents metal particles from being penetrated into the product, and is transferred for packing into a retail packaging, the packing is performed in the nitrogen atmosphere at the pressure of 1.0 atm.

### Example 12

The mixer is loaded with 0.4 kg of cedar nut press-cake, 0.05 kg of ascorbyl palmitate, 0.01 kg of tocopherol oil solution (50% d1-alpha Tocopherol acetate in oil), and the antioxidant is applied as shown in Example 1.

The press-cake treated with the antioxidant is compounded with 94.45 kg of lactose-free whey protein isolate, 1.5 kg of inuline, 1.0 kg of microcrystalline cellulose, 1.0 kg of (gluten-free) apple fibers, 0.1 kg of xanthan gum, 0.1 kg of guar gum, 0.1 kg of konjac gum, 0.1 kg of apple pectin, 0.412 kg of potassium citrate, 0.44 kg of amorphous silicon dioxide, 0.033 kg of sucralose, 0.167 kg of natural flavor “green apple”, 0.1 kg of vitamin premix (containing the following vitamins [in the forms approved for use in food and pharmaceutical industries, in wt. % of a premix mass]: A (0.35 wt. %), B₁ (0.61 wt. %), B₂ (0.714 wt. %), B₆ (0.714 wt. %), B₁₂ (0.001 wt. %), PP (7.14 wt. %), folic acid (0.143 wt. %), pantothenic acid (1.78 wt. %), biotin (0.018 wt. %), E (5.35 wt. %), D₃ (0.0017 wt. %), 0.1 kg of mineral premix (containing the following minerals [in the forms approved for use in food and pharmaceutical industries, in wt. % of a premix mass]: calcium (16 wt. %), magnesium (11.6 wt. %), potassium (11.6 wt. %), iron (4.6 wt. %), zinc (2.84 wt. %), iodine (0.043 wt. %), selenium (0.0137 wt. %), copper (0.38 wt. %), manganese (0.3 wt. %)), and all the components are mixed until the components are homogeneous distributed.

Next, the resulted mixture is transferred for milling. The mill crusher 40-V (China), 60 kg/h, main shaft revolutions 3400 min⁻¹. The operation is performed twice, the final particle size is no more than 50 mesh.

The milled, homogenized and dry mixture passes through the magnetic separator (with rod diameters of 22 mm and the magnetic intensity at the rod surface of 1 T), which prevents metal particles from being penetrated into the product, and is transferred for packing into a retail packaging, the packing is performed in the nitrogen atmosphere at the pressure of 1.0 atm.

### Example 13

The mixer is loaded with 9.532 kg of cedar nut press-cake, 0.50 kg of ascorbyl palmitate, 0.168 kg of tocopherol oil solution (50% d1-alpha Tocopherol acetate in oil), and the antioxidant is applied as shown in Example 1.

The press-cake treated with the antioxidant is compounded with 15.85 kg of lactose-free whey protein isolate, 1.5 kg of inuline, 70.0 kg of microcrystalline cellulose, 1.0 kg of (gluten-free) apple fibers, 0.1 kg of xanthan gum, 0.1 kg of guar gum, 0.1 kg of konjac gum, 0.1 kg of apple pectin, 0.412 kg of potassium citrate, 0.3 kg of amorphous silicon dioxide, 0.033 kg of sucralose, 0.167 kg of natural apple flavor, 0.1 kg of vitamin premix (containing the following vitamins [in the forms approved for use in food and pharmaceutical industries, in wt. % of a premix mass]: A (0.35 wt. %), B₁ (0.61 wt. %), B₂ (0.714 wt. %), B₆ (0.714 wt. %), B₁₂ (0.001 wt. %), PP (7.14 wt. %), folic acid (0.143 wt. %), pantothenic acid (1.78 wt. %), biotin (0.018 wt. %), E (5.35 wt. %), D₃ (0.0017 wt. %), 0.1 kg of mineral premix (containing the following minerals [in the forms approved for use in food and pharmaceutical industries, in wt. % of a premix mass]: calcium (16 wt. %), magnesium (11.6 wt. %), potassium (11.6 wt. %), iron (4.6 wt. %), zinc (2.84 wt. %), iodine (0.043 wt. %), selenium (0.0137 wt. %), copper (0.38 wt. %), manganese (0.3 wt. %)), and all the components are mixed until the components are homogeneous distributed.

Next, the resulted mixture is transferred for milling. The mill crusher 40-V (China), 60 kg/h, main shaft revolutions 3400 min⁻¹. The operation is performed twice, the final particle size is no more than 50 mesh.

The milled, homogenized and dry mixture passes through the magnetic separator (with rod diameters of 22 mm and the magnetic intensity at the rod surface of 1 T), which prevents metal particles from being penetrated into the product, and is transferred for packing into a retail packaging, the packing is performed in the nitrogen atmosphere at the pressure of 1.0 atm.

### Example 14

The mixer is loaded with 10.00 kg of pistachio press-cake, 0.50 kg of ascorbyl palmitate, 0.168 kg of tocopherol oil solution (50% d1-alpha Tocopherol acetate in oil), and the antioxidant is applied as shown in Example 1.

The press-cake treated with the antioxidant is compounded with 48.70 kg of lactose-free whey protein hydrolysate, 1.5 kg of inuline, 12.81 kg of purified food lignin and 7.81 kg of barn of Plantago psyllium seeds, 15.00 kg of (gluten-free) apple fibers, 0.333 kg of xanthan gum, 0.333 kg of guar gum, 0.333 kg of konjac gum, 0.333 kg of apple pectin, 0.814 kg of potassium tartrate, 0.5 kg of amorphous silicon dioxide, 0.033 kg of sucralose, 0.167 kg of natural apple flavor, 0.333 kg of vitamin premix (containing the following vitamins [in the forms approved for use in food and pharmaceutical industries, in wt. % of a premix mass]: A (0.35 wt. %), B₁ (0.61 wt. %), B₂ (0.714 wt. %), B₆ (0.714 wt. %), B₁₂ (0.001 wt. %), PP (7.14 wt. %), folic acid (0.143 wt. %), pantothenic acid (1.78 wt. %), biotin (0.018 wt. %), E (5.35 wt. %), D₃ (0.0017 wt. %), 0.333 kg of mineral premix (containing the following minerals [in the forms approved for use in food and pharmaceutical industries, in wt. % of a premix mass]: calcium (16 wt. %), magnesium (11.6 wt. %), potassium (11.6 wt. %), iron (4.6 wt. %), zinc (2.84 wt. %), iodine (0.043 wt. %), selenium (0.0137 wt. %), copper (0.38 wt. %), manganese (0.3 wt. %)), and all the components are mixed until the components are homogeneous distributed.

Next, the resulted mixture is transferred for milling. The mill crusher 40-V (China), 60 kg/h, main shaft revolutions 3400 min⁻¹. The operation is performed twice, the final particle size is no more than 50 mesh.

The milled, homogenized and dry mixture passes through the magnetic separator (with rod diameters of 22 mm and the magnetic intensity at the rod surface of 1 T), which prevents metal particles from being penetrated into the product, and is transferred for packing into a retail packaging, the packing is performed in the nitrogen atmosphere at the pressure of 1.0 atm.

### Example 15

10.00 kg of cedar nut press-cake, 0.20 kg of rosemary fat extract (the mass fraction of carnosic acid is no less than 4.0%) are loaded into the mixer and are mixed until antioxidants are fully distributed in the mixture, meanwhile controlling the impregnation of the antioxidant by the press-cake particles. The impregnation control is performed on press-cake samples taken during mixing which are sectioned and evaluated for the degree of the antioxidant penetration into the particles which is assessed by the way how the color changes from the particle surface towards the particle inside. The mixing is stopped if the impregnation beginning test exhibits the positive outcome.

Next, the treated press-cake is milled (in the roll crusher DV 300 with smooth rollers and the gap between rollers of 0.5 mm) to stimulate impregnation.

The resulted press-cake is compounded with 48.70 kg of lactose-free whey protein isolate, 1.5 kg of inuline, 20.62 kg of microcrystalline cellulose, 15.00 kg of (gluten-free) apple fibers, 0.333 kg of xanthan gum, 0.333 kg of guar gum, 0.333 kg of konjac gum, 0.333 kg of apple pectin, 0.814 kg of potassium citrate, 0.5 kg of amorphous silicon dioxide, 0.033 kg of sucralose, 0.167 kg of natural apple flavor, 0.333 kg of vitamin premix (containing the following vitamins [in the forms approved for use in food and pharmaceutical industries, in wt. % of a premix mass]: A (0.35 wt. %), B₁ (0.61 wt. %), B₂ (0.714 wt. %), B₆ (0.714 wt. %), B₁₂ (0.001 wt. %), PP (7.14 wt. %), folic acid (0.143 wt. %), pantothenic acid (1.78 wt. %), biotin (0.018 wt. %), E (5.35 wt. %), D₃ (0.0017 wt. %), 0.333 kg of mineral premix (containing the following minerals [in the forms approved for use in food and pharmaceutical industries, in wt. % of a premix mass]: calcium (16 wt. %), magnesium (11.6 wt. %), potassium (11.6 wt. %), iron (4.6 wt. %), zinc (2.84 wt. %), iodine (0.043 wt. %), selenium (0.0137 wt. %), copper (0.38 wt. %), manganese (0.3 wt. %)), and is mixed until the components are homogeneously distributed.

Next, the resulted mixture is transferred for milling.

The mill crusher 40-V (China), 60 kg/h, main shaft revolutions 3400 min⁻¹. The operation is performed twice, the final particle size is no more than 50 mesh.

The milled, homogenized and dry mixture passes through the magnetic separator (with rod diameters of 22 mm and the magnetic intensity at the rod surface of 1 T), which prevents metal particles from being penetrated into the product, and is transferred for packing into a retail packaging, the packing is performed in the nitrogen atmosphere at the pressure of 1.0 atm.

### Example 16

The mixer is loaded with 10.10 kg of walnut press-cake and 0.50 kg of rosemary extract and the antioxidant is applied, as shown in Example 15.

The treated press-cake is compounded with 48.501 kg of soy protein concentrate, 1.5 kg of inuline, 20.62 kg of buckwheat barn, 15.00 kg of (gluten-free) apple fibers, 0.333 kg of xanthan gum, 0.333 kg of guar gum, 0.333 kg of konjac gum, 0.333 kg of apple pectin, 0.314 kg of magnesium lactate, 0.3 kg of potassium acetate, 0.2 kg of calcium phosphate, 0.35 kg of amorphous silicon dioxide, 0.1 kg of talc, 0.05 kg of calcium stearate, 0.3 kg of stevia extract, 0.167 kg of natural apple flavor, 0.333 kg of vitamin premix (containing the following vitamins [in the forms approved for use in food and pharmaceutical industries, in wt. % of a premix mass]: A (0.35 wt. %), B₁ (0.61 wt. %), B₂ (0.714 wt. %), B₆ (0.714 wt. %), B₁₂ (0.001 wt. %), PP (7.14 wt. %), folic acid (0.143 wt. %), pantothenic acid (1.78 wt. %), biotin (0.018 wt. %), E (5.35 wt. %), D₃ (0.0017 wt. %), 0.333 kg of mineral premix (containing the following minerals [in the forms approved for use in food and pharmaceutical industries, in wt. % of a premix mass]: calcium (16 wt. %), magnesium (11.6 wt. %), potassium (11.6 wt. %), iron (4.6 wt. %), zinc (2.84 wt. %), iodine (0.043 wt. %), selenium (0.0137 wt. %), copper (0.38 wt. %), manganese (0.3 wt. %)), and all the components are mixed until the components are homogeneous distributed.

Next, the resulted mixture is transferred for milling. The mill crusher 40-V (China), 60 kg/h, main shaft revolutions 3400 min⁻¹. The operation is performed twice, the final particle size is no more than 50 mesh.

The milled, homogenized and dry mixture passes through the magnetic separator (with rod diameters of 22 mm and the magnetic intensity at the rod surface of 1 T), which prevents metal particles from being penetrated into the product, and is transferred for packing into a retail packaging, the packing is performed in the nitrogen atmosphere at the pressure of 1.0 atm.

### Example 17

The mixer is loaded with 10.00 kg of almond press-cake, 0.50 kg of ascorbyl palmitate and 0.168 kg of dry tocopherol (50% d1-alpha Tocopherol acetate), and all components are mixed until antioxidants are fully distributed in the mixture. The resulted mixture is compounded with 48.70 kg of pea protein concentrate, 1.5 kg of inuline, 20.62 kg of barley barn, 15.00 kg of (gluten-free) apple fibers, 0.333 kg of xanthan gum, 0.333 kg of guar gum, 0.333 kg of konjac gum, 0.333 kg of apple pectin, 0.519 kg of potassium malate, 0.295 kg of sodium fumarate, 0.2 kg of amorphous silicon dioxide, 0.1 kg of kaolin, 0.1 kg of calcium carbonate, 0.1 kg of fine-grained bentonite (particle size no more than 10 μm), 0.033 kg of sucralose, 0.167 kg of natural apple flavor, 0.333 kg of vitamin premix (containing the following vitamins [in the forms approved for use in food and pharmaceutical industries, in wt. % of a premix mass]: A (0.35 wt. %), B₁ (0.61 wt. %), B₂ (0.714 wt. %), B₆ (0.714 wt. %), B₁₂ (0.001 wt. %), PP (7.14 wt. %), folic acid (0.143 wt. %), pantothenic acid (1.78 wt. %), biotin (0.018 wt. %), E (5.35 wt. %), D₃ (0.0017 wt. %), 0.333 kg of mineral premix (containing the following minerals [in the forms approved for use in food and pharmaceutical industries, in wt. % of a premix mass]: calcium (16 wt. %), magnesium (11.6 wt. %), potassium (11.6 wt. %), iron (4.6 wt. %), zinc (2.84 wt. %), iodine (0.043 wt. %), selenium (0.0137 wt. %), copper (0.38 wt. %), manganese (0.3 wt. %)), and all the components are mixed until the components are homogeneous distributed.

Next, the resulted mixture is transferred for milling. The mill crusher 40-V (China), 60 kg/h, main shaft revolutions 3400 min⁻¹. The operation is performed twice, the final particle size is no more than 50 mesh.

The milled, homogenized and dry mixture passes through the magnetic separator (with rod diameters of 22 mm and the magnetic intensity at the rod surface of 1 T), which prevents metal particles from being penetrated into the product, and is transferred for packing into a retail packaging, the packing is performed in the nitrogen atmosphere at the pressure of 1.0 atm.

### Example 18

The product from Example 1 has low caloric value—310 kcal per 100 g (1300 kJ per 100 g), which in combination with the high mass fraction of biologically active components, in particular: polyunsaturated fatty acids, including OMEGA-6; phospholipids, highly digestible protein, dietary fibers (soluble and insoluble), inuline. The aminoacid formulation of the product is shown in Table 1, the fatty acid formulation of the product is shown in Table 2, the vitamin and mineral formulation of the product is shown in Table 3.

TABLE 1
The aminoacid composition of the product of Example 1.

| | Mass fraction per 100 g of |
|---|---|
| Component name | product, g |
| Threonine | 3.06 |
| Valine | 2.87 |
| Cystine + cysteine | 1.08 |
| Methionine | 1.20 |
| Isoleucine | 2.96 |
| Leucine | 4.88 |
| Lysine | 4.74 |
| Tryptophan | 0.80 |
| Phenylalanine | 1.56 |
| Tyrosine | 1.52 |
| Asparagine | 5.35 |
| Serin | 2.55 |
| Glutamine | 8.77 |
| Proline | 2.95 |
| Glycine | 1.09 |
| Alanin | 2.57 |
| Histidine | 0.90 |
| Arginine | 2.79 |

TABLE 2
The fatty acid composition of the product of Example 1.

| | Mass fraction per 100 g of |
|---|---|
| Component name | product, g |
| Myristic acid (14:0) | 0.04 (from 0.01 to 0.10) |
| Palmitic (16:0) | 0.75 (from 0.30 to 1.50) |
| Palmitoleic, (16:1 n7) | 0.12 (from 0.05 to 0.20) |
| Margaric (17:0) | 0.31 (from 0.10 to 0.50) |
| Stearic (18:0) | 0.35 (from 0.10 to 0.50) |
| Oleic acid (18:1 n9 cis) + elaidic | 3.01 (from 0.10 to 0.50) |
| (18:1 n9 trans) | |
| Cis-vaccenic (18:1 n11 cis) | 0.21 (from 0.10 to 0.50) |
| Linoleic (18:2 n6) | 5.29 (from 1.5 to 9.45) |
| Gamma-linolenic (18:3 n6) | 2.37 (from 1.20 to 4.5) |
| Alpha-linolenic (18:3 n3) | 0.06 (from 0.01 to 0.7) |
| Arachic (20:0) | 0.05 (from 0.01 to 0.10) |
| Cis-11-eicosenic (20:1 n9) | 0.13 (from 0.05 to 0.50) |
| Cis-11, 14-eicosadienoic (20:2 n6) | 0.03 (from 0.01 to 0.10) |
| Heneicosanic (21:0) | 0.01 (from 0.005 to 0.05) |
| Cis-11,14,17-eicosatrienoic (20:3 n3) | 0.026 (from 0.005 to 0.05) |
| Behenic (22:0) | 0.01 (from 0.005 to 0.05) |
| Cis-5,8,11,14,17-eicosapentaenoic | 0.05 (from 0.005 to 0.60) |
| acid (20:5 n3) | |
| Tricosanoic acid (23:0) | 0.03 (from 0.005 to 0.08) |
| Saturated fatty acids | 1.57 (from 0.50 to 25.0) |
| Monounsaturated fatty acids | 3.46 (from 1.00 to 15.0) |
| Polyunsaturated fatty acids | 7.83 (from 1.50 to 20.00) |
| OMEGA-3 | 0.14 (from 0.05 to 5.00) |
| OMEGA-6 | 7.69 (from 1.5 to 20.0) |
| OMEGA-9 | 3.14 (from 1.00 to 7.5) |

TABLE 3
Vitaminic and 14 mineral composition
of the product of Example 1.

| | Mass fraction per 100 g of |
|---|---|
| Component name | product, mg |
| Vitamin A | 1.17 |
| Vitamin B1 | 2.03 |
| Vitamin B2 | 2.38 |
| Vitamin B3 (niacin) | 23.78 |
| Vitamin B5 (pantothenic acid) | 5.93 |
| Vitamin B6 | 2.38 |
| Vitamin H (biotin) | 0.06 |
| Vitamin B9 (folic acid) | 0.48 |
| Vitamin B12 | 0.00333 |
| Vitamin C | 583.25 |
| Vitamin D3 (cholicacerferol) | 0.0057 |
| Vitamin E | 17.82 |
| Iron | 15.32 |
| Iodine | 0.14 |
| Potassium | 39.04 |
| Calcium | 53.31 |
| Magnesium | 38.63 |
| Manganese | 1.00 |
| Copper | 1.27 |
| Selenium | 0.046 |
| Zinc | 9.46 |

In this way, the present invention provides a concentrate for preparation of a cocktail which, due to the homogeneous distribution of the antioxidant over the surface of the particles of the nut press-cake, has the shelf life approximately 2 times longer and the sensory characteristics of the product remained unchanged.

The use of the composition according to the present invention as a dietary supplement has proved its nutritional value as a source of protein, dietary fibers, inuline, phospholipids, polyunsaturated fatty acids, including OMEGA-6; and as an additional source of vitamins and minerals.

The use of the composition according to the present invention has proved that one or more meals can be successfully replaced with a cocktail made with the use of the composition and a liquid food product, e.g., milk, yogurt or fruit juice, etc. At the same time, the consumption of the composition according to the present invention as a part of a basic diet has proved that it can be used as an agent for weight loss and a digestion improvement, where both actions are guaranteed by the prebiotic activity and due to the presence of inuline and various dietary fibers in the composition.

The user experience has shown that the composition according to the present invention provides the possibility of making a hypoallergenic concentrate for the preparation of a cocktail that addresses all the main problems of a human healthy nutrition due to the natural ingredients, high flavor qualities of the finished product and the functionality of the composition, since the composition has proteins, fats, carbohydrates and nutrients at the optimally balanced ratio. Therefore, it is now possible to promote the human health by using food products based on the composition according to the present invention.

1. A dry concentrate for preparation of a protein cocktail, comprising a nut press-cake, a protein source, a source of soluble fibers, characterized in that said concentrate further comprises a source of insoluble fibers, a vitamin premix, a mineral premix, an antioxidant and at least one auxiliary component, these components are at the following ratio, wt. %:

| | |
|---|---|
| the nut press-cake | from 0.4 to 93.85, |
| the protein source | from 1.0 to 94.45, |
| the source of soluble fibers | from 1.0 to 30.0, |
| the source of insoluble fibers | from 1.0 to 70.0, |
| the vitamin premix | from 0.1 to 5.0, |
| the mineral premix | from 0.1 to 5.0, |
| the antioxidant | from 0.05 to 0.5, |
| auxiliary components | from 2.5 to 25.0, |

wherein the antioxidant is homogeneously pre-distributed over a surface of the particles of said nut press-cake.

2. The concentrate according to claim 1, characterized in that said concentrate comprises components at the following ratio, wt. %:

| | |
|---|---|
| the nut press-cake | from 5.0 to 50.0, |
| the protein source | from 30.0 to 65.0, |
| the source of soluble fibers | from 1.0 to 15.0, |
| the source of insoluble fibers | from 1.0 to 50.0, |
| the vitamin premix | from 0.1 to 1.0, |
| the mineral premix | from 0.1 to 1.0, |
| the antioxidant | from 0.05 to 0.3, |
| auxiliary components | from 2.5 to 10.0. |

3. The concentrate according to claim 1, characterized in that said concentrate comprises components at the following ratio, wt. %:

| | |
|---|---|
| the nut press-cake | from 5.0 to 35.0, |
| the protein source | from 30.0 to 40.0, |
| the source of soluble fibers | from 5.0 to 10.0, |
| the source of insoluble fibers | from 10.0 to 20.0, |
| the vitamin premix | from 0.1 to 0.5, |
| the mineral premix | from 0.1 to 0.5, |
| the antioxidant | from 0.1 to 0.25, |
| auxiliary components | from 3.0 to 5.0, |

4. The concentrate according to claim 1, characterized in that the nut press-cake is selected from the group including cedar nut press-cake, peanut press-cake, almond press-cake, walnut press-cake, hazelnut press-cake, cashew press-cake, brazil nut press-cake, water chestnut press-cake, pecan press-cake, pistachio press-cake, macadamia press-cake, or a mixture of two or more of said press-cakes.

5. The concentrate according to claim 1, characterized in that the nut press-cake is produced by the cold pressing method.

6. The concentrate according to claim 1, characterized in that the protein source is selected from the group including milk protein hydrolysate, lactose-free whey protein isolate, soy protein isolate, soy protein concentrate, pea protein isolate, pea protein concentrate, protein isolate of sunflower kernels, protein concentrate of sunflower kernels, amaranth protein isolate, amaranth protein concentrate, bean protein isolate, bean protein concentrate, chickpea protein isolate, chickpea protein concentrate, Chorella algae, chorella protein isolate, chorella protein concentrate.

7. The concentrate according to claim 1, characterized in that the source of soluble fibers is selected from the group including inuline, gluten-free apple fibers, xanthan gum, guar gum, konjac gum, apple pectin or a mixture of two or more of said sources of soluble fibers.

8. The concentrate according to claim 1, characterized in that the source of insoluble fibers is selected from the group including microcrystalline cellulose, chitin, chitosan, lignin, hemicellulose, bran of Plantago psyllium seeds, wheat bran, rye bran, barley bran, rice bran, soy bran, buckwheat bran, linseed bran, fruit fibers, or a mixture of two or more of said sources of insoluble fibers.

9. The concentrate according to claim 1, characterized in that the antioxidant is selected from the group including ascorbyl palmitate, ascorbyl stearate, and tocopherol, rosemary natural extract.

10. The concentrate according to claim 1, characterized in that as the vitamin premix a set of vitamins and/or vitamin-like substances is used selected from the group including vitamin A, vitamin B₁, vitamin B₂, vitamin B₃, vitamin B₄ (choline), vitamin B₅, vitamin B₆, vitamin B₈ (inositol), vitamin B₉, vitamin B₁₂, vitamin B₁₃ (orotic acid), vitamin C, vitamin D₃, vitamin E, vitamin H (biotin), vitamin K

11. The concentrate according to claim 1, characterized in that as the mineral premix a set of mineral substances is used which is selected from the group including mineral substances, comprising iron, iodine, potassium, calcium, magnesium, manganese, copper, selenium, zinc, phosphorus, molybdenum, chromium (III), silicon, cobalt, fluorine, vanadium, boron, silver.

12. The concentrate according to claim 1, characterized in that at least one auxiliary component is selected from the group including a sweetener, a natural hypoallergenic flavor, an anticaking agent, an acidity regulator.

13. The concentrate according to claim 12, characterized in that the sweetener is selected from the group including aspartame, acesulfame potassium, aspartame-acesulfame salt, isomalt, xylitol, lactitol, maltitol, mannitol, neohesperidin dihydrochalcon, saccharin and the salts thereof, sorbitol, sucralose, stevia, stevia leaf extract, stevioside, thaumatin, cyclamic acid and the salts thereof, erythritol.

14. The concentrate according to claim 12, characterized in that as the natural hypoallergenic flavor a natural flavor “green apple” is used.

15. The concentrate according to claim 12, characterized in that the anticaking agent is selected from the group including amorphous silicon dioxide, talc, calcium carbonate, carbonates of magnesium, aluminum salts of fatty acids, ammonium salts of fatty acids, potassium salts of fatty acids, calcium salts of fatty acids, magnesium salts of fatty acids, sodium salts of fatty acids, magnesium oxide, calcium silicate, magnesium silicates, aluminosilicates of sodium, calcium, potassium, bentonite, kaolin.

16. The concentrate according to claim 15, characterized in that fatty acids are selected from the group including myristic acid, oleic acid, palmitic acid, stearic acid or the mixtures thereof.

17. The concentrate according to claim 12, characterized in that the acidity regulator is selected from the group including potassium citrate, potassium acetate, sodium acetate, calcium acetate, potassium lactate, calcium lactate, magnesium lactate, sodium citrate, potassium citrate, calcium citrate, sodium tartrate, potassium tartrate, sodium-potassium tartrate, calcium tartrate, sodium phosphates, potassium phosphates, calcium phosphates, magnesium phosphates, sodium malate, potassium malate, calcium malate, sodium fumarate.

18. The concentrate according to claim 1, characterized in that the caloric value of said concentrate is no more than 310 kcal per 100 g.

19. The concentrate according to claim 1, characterized in that a mass fraction of fats in the concentrate is no more than 15 wt. %, wherein a mass fraction of polyunsaturated fatty acids of fats in said concentrate is from 5 to 10 wt. %, and a mass fraction of phospholipids in said concentrate is from 1.05 to 15.0 wt. %.

20. The concentrate according to claim 1, characterized in that a mass fraction of carbohydrates in said concentrate is no more than 10 wt. %.

21. The concentrate according to claim 1, characterized in that a mass fraction of protein in said concentrate is no less than 40 wt. %, and a mass fraction of highly digestible protein is from 40 to 95 wt. %.

22. The concentrate according to claim 1, characterized in that a mass fraction of fibers in said concentrate is from 20 to 30 wt. %

23. The concentrate according to claim 1, characterized in that the nut press-cake is mixed with the antioxidant until the antioxidant is completely distributed over the mixture.

24. A protein cocktail, produced from the concentrate according to claim 1 by mixing the concentrate with a required amount of a liquid food product.

25. The protein cocktail according to claim 24, characterized in that the liquid food product is selected from the group including potable water, milk, defatted kefir, defatted yogurt, fruit juice, vegetable juice.
